(19) United States
(12) Patent Application Publication
(10) Pub. No.: US 2022/0237943 A1
(43) Pub. Date: Jul. 28, 2022

(54) METHOD AND APPARATUS FOR ADJUSTING CABIN ENVIRONMENT

(71) Applicant: Shanghai SenseTime Lingang Intelligent Technology Co., Ltd., Shanghai (CN)

(72) Inventors: Fei WANG, Shanghai (CN); Chen QIAN, Shanghai (CN)

(21) Appl. No.: 17/722,554

(22) Filed: Apr. 18, 2022

Related U.S. Application Data
(63) Continuation of application No. PCT/CN2020/135500, filed on Dec. 10, 2020.

(30) Foreign Application Priority Data
Mar. 30, 2020 (CN) 202010237887.1

(51) Int. Cl. G06V 40/16; G06V 10/82; G06V 10/774; G06V 10/776; G06V 40/18; G06V 10/77

(52) U.S. Cl. CPC G06V 40/161; G06V 40/178; G06V 10/82; G06V 10/7747; G06V 10/7715; G06V 40/169; G06V 40/172; G06V 40/193; G06V 40/176; G06V 10/776

(57) ABSTRACT

A cabin interior environment adjustment method and apparatus are provided. Said method comprises: acquiring a face image of a person in a cabin; determining attribute information and state information of the person in the cabin on the basis of the face image; and adjusting a cabin interior environment on the basis of the attribute information and the state information of the person in the cabin.

### CROSS-REFERENCE TO RELATED APPLICATION

This disclosure is a continuation application of International Patent Application No. PCT/CN2020/135500, filed on Dec. 10, 2020, which claims priority to Chinese patent application No. 202010237887.1, filed on Mar. 30, 2020. The disclosures of International Patent Application No. PCT/CN2020/135500 and Chinese patent application No. 202010237887.1 are hereby incorporated by reference in their entireties.

### BACKGROUND

In the related art, during the process of setting the cabin environment, for example, when it is necessary to adjust the temperature in the cabin, to adjust the music played in the cabin, it is generally manually adjusted by the user. With the development of face recognition technology, the corresponding environmental information can be set for each user in advance. After the user gets in the car, the user's identity is recognized through the face recognition technology, and after the user's identity is recognized, the environmental information corresponding to the identity is acquired, and then the cabin environment is set.

### SUMMARY

The present disclosure relates to the field of computer technology, and particularly relates to a method and apparatus for adjusting cabin environment.

The embodiments of the present disclosure at least provide a method and apparatus for adjusting cabin environment.

In the first aspect, the embodiments of the present disclosure provide a method for adjusting cabin environment. The method includes the following operations.

A face image of a person in a cabin is acquired.

The attribute information and status information of the person in the cabin are determined based on the face image.

The cabin environment is adjusted based on the attribute information and the status information of the person in the cabin.

In the second aspect, the embodiments of the present disclosure further provide an electronic device. The device includes a processor, a memory storing machine-readable instructions executable by the processor, and a bus. The processor is configured to: acquire a face image of a person in a cabin; determine attribute information and status information of the person in the cabin based on the face image; and adjust the cabin environment based on the attribute information and the status information of the person in the cabin.

In the third aspect, the embodiments of the present disclosure further provide a non-transitory computer-readable storage medium having stored therein a computer program that when executed by a processor, implements a method for adjusting cabin environment, which includes that: a face image of a person in a cabin is acquired; the attribute information and status information of the person in the cabin are determined based on the face image; the cabin environment is adjusted based on the attribute information and the status information of the person in the cabin.

The description of the effects of the above apparatus for adjusting cabin environment, electronic device, and computer-readable storage medium refer to the above description of the method for adjusting cabin environment, which will not be repeated here.

In order to make the above objectives, features and advantages of the embodiments of the present disclosure more obvious and understandable, preferred embodiments are described in detail below in conjunction with accompanying drawings.

### BRIEF DESCRIPTION OF THE DRAWINGS

In order to explain the technical solutions in the embodiments of the present disclosure more clearly, the following will briefly introduce the accompanying drawings needed in the embodiments. The accompanying drawings here are incorporated to the specification and constitute a part of the specification. These accompanying drawings illustrate embodiments conforming to the present disclosure, and is used together with the specification to explain the technical solutions in the embodiments of the present disclosure. It should be understood that the following accompanying drawings only illustrate some embodiments of the present disclosure, and therefore should not be regarded as limiting the scope. For those of ordinary skill in the art, they can also obtain other related drawings based on these accompanying drawings without any creative effort.

FIG. 1 illustrates a schematic flowchart of a method for adjusting cabin environment according to an embodiment of the present disclosure.

FIG. 2 illustrates a schematic flowchart of a method for training a first neural network according to an embodiment of the present disclosure.

FIG. 3 illustrates a schematic flowchart of a method for determining an enhanced sample image according to an embodiment of the present disclosure.

FIG. 4 illustrates a schematic flowchart of a method for determining gender information of a person in a cabin according to an embodiment of the present disclosure.

FIG. 5 illustrates a schematic flowchart of a method for determining a set threshold according to an embodiment of the present disclosure.

FIG. 6 illustrates a schematic flowchart of a method for determining eye opening-closing information of a person in a cabin according to an embodiment of the present disclosure.

FIG. 7 illustrates a schematic flowchart of a method for determining attribute information according to an embodiment of the present disclosure.

FIG. 8 illustrates a schematic diagram of a network structure of an information extraction neural network according to an embodiment of the present disclosure.

FIG. 9 illustrates a schematic flowchart of a method for determining emotional information of a person in a cabin according to an embodiment of the present disclosure.

FIG. 10 illustrates an architecture diagram of an apparatus for adjusting cabin environment according to an embodiment of the present disclosure.

FIG. 11 illustrate a schematic diagram of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be described clearly and completely in conjunction with the accompanying drawings in the embodiments of the present disclosure. It is apparent that the described embodiments are merely a part of the embodiments of the present disclosure, but not all of the embodiments. The components of the embodiments of the present disclosure generally described and illustrated in the accompanying drawings herein may be arranged and designed in a variety of different configurations. Therefore, the following detailed description of the embodiments of the present disclosure provided in the accompanying drawings is not intended to limit the protection scope of the present disclosure, but merely represents selected embodiments of the present disclosure. Based on the embodiments of the present disclosure, all other embodiments obtained by those skilled in the art without creative effort shall fall within the protection scope of the present disclosure.

In the related art, during the process of adjusting the environment settings in the cabin, there are two methods. In one method, the cabin environment is manually adjusted; and in the other method, the environment setting information corresponding to each user is set in advance, and then the identity information of the passengers in the cabin is recognized, the environment setting is adjusted according to the environment setting information corresponding to the identity information based on the recognized identity information. If the passengers in the cabin have not set the corresponding environment setting information in advance, or the passengers in the cabin do not want to set the cabin environment according to the environment setting information set in advance, the passengers still need to manually adjust the environment settings in the cabin.

Then, the embodiments of the present disclosure provide a method for adjusting cabin environment. In this method, a face image of a person in a cabin can be acquired in real time, and the attribute information and emotional information of the person in the cabin can be determined based on the face image, and then the environment setting in the cabin can be adjusted based on the attribute information and emotional information of the person in the cabin. In such a manner, since the face image is acquired in real time, the determined attribute information and emotional information of the person in the cabin can represent the current status of the person in the cabin, and the environment setting in the cabin may be adjusted according to the current status of the person in the cabin, and the environment setting in the cabin can be automatically and dynamically adjusted.

The defects in the above solutions are all the results obtained by the inventor after practice and careful study, and therefore, the discovery process of the above problems and the solutions proposed by the present disclosure below with respect to the above problems should be covered within the protection scope of the present disclosure.

It should be noted that similar reference numerals and letters indicate similar items in the following accompanying drawings, and therefore, once an item is defined in one accompanying drawing, it does not need to be further defined and explained in the subsequent accompanying drawings.

In order to facilitate the understanding of this embodiment, the method for adjusting cabin environment disclosed in the embodiments of the present disclosure is firstly introduced in detail. The perform entity of the method for adjusting cabin environment according to the embodiments of the present disclosure is generally an electronic device with certain calculation capabilities. The cabins may include, but are not limited to, car cabins, train cabins, boat cabins, etc. For other devices with adjustable environments, the methods according to the embodiments of the present disclosure are all applicable.

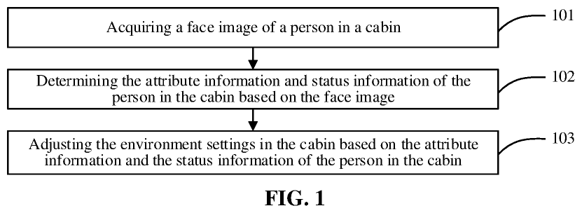

With reference to FIG. 1 illustrating a schematic flowchart of a method for adjusting cabin environment according to an embodiment of the present disclosure, the method includes the following operations.

In operation 101, a face image of a person in a cabin is acquired.

In operation 102, the attribute information and status information of the person in the cabin are determined based on the face image.

In operation 103, the cabin environment is adjusted based on the attribute information and the status information of the person in the cabin.

By the above method, the face image of the person in the cabin can be acquired in real time, and the attribute information and emotional information of the person in the cabin can be determined based on the face image, and then the environment setting in the cabin can be adjusted based on the attribute information and emotional information of the person in the cabin. By this method, since the face image is acquired in real time, the determined attribute information and emotional information of the person in the cabin can represent the current status of the person in the cabin, and the environment setting in the cabin may be adjusted according to the current status of the person in the cabin, and the environment setting in the cabin can be adjusted automatically and dynamically.

The following is a detailed description of the above operation 101 to operation 103.

With respect to operation 101:

The face image of the person in the cabin may be an image including the complete face of the person in the cabin. During the process of acquiring the face image of the person in the cabin, the collected image to be detected may be firstly acquired, and then the face region information in the image to be detected is determined based on the trained face detection neural network for face detection, and finally the face image is determined based on the face region information.

The image to be detected may be collected in real time and acquired in real time. In a possible implementation, the image to be detected may be captured in real time by a camera installed in the cabin.

The face region information in the image to be detected includes the coordinate information of the center point of the detection frame corresponding to the face region and the size information of the detection frame. During the process of determining the face image based on the face region information, the size information of the detection frame can be enlarged according to the preset ratio to obtain the enlarged size information, and then the face image is cropped from the image to be detected, based on the coordinate information of the center point and the enlarged size information.

The region corresponding to the detection frame output by the face detection neural network may not contain the face information of all persons in the cabin, and therefore, the detection frame can be enlarged to make the obtained face image contain all of the face information.

In a possible implementation, the size information may include the length of the detection frame and the width of the detection frame. During the process of enlarging the size information of the detection frame according to a preset ratio, the length of the detection frame and the width of the detection frame may be separately enlarged according to corresponding preset ratios, the preset ratio corresponding to the length of the detection frame and the preset ratio corresponding to the width of the detection frame may be the same.

Exemplarily, when the preset ratios corresponding to the length of the detection frame and the width of the detection frame are both 10%, and the length of the detection frame is a and the width of the detection frame is b, then after the enlarged processing, the length of the detection width is 1.1a, and the width of the detection frame is 1.1b.

During the process of cropping the face image from the image to be detected based on the coordinate information of the center point and the enlarged size information, the point corresponding to the coordinate information of the center point can be taken as the intersection of the diagonals, and then the length and width in the enlarged size information are taken as the length and width of the detection frame to determine the position of the detection frame in the image to be detected, and finally, the detection frame is taken as the dividing line to crop the image from the image to be detected, and the cropped image is the face image.

During the training of the face detection neural network, the sample data of the face detection neural network can be sample images, each sample image has corresponding label data, and the label data corresponding to the sample image includes the coordinate information of the center point in the sample image and the size information corresponding to the detection frame in the sample image; after each sample image is input to the face detection neural network, the face detection neural network can obtain the predicted coordinate information of the center point and the predicted size information of the detection frame; and then based on the predicted coordinate information of the center point, the predicted size information of the detection frame, and the label data corresponding to the sample image, the loss value during this training process is determined; and in the case that the loss value does not satisfy the preset conditions, the network parameter value of the face detection neural network during this training process is adjusted.

With respect to operation 102:

The attribute information of the person in the cabin may include at least one of: age information; gender information. The status information of the person in the cabin may include the emotional information and the eye opening-closing information of the person in the cabin. The eye opening-closing information may be used to detect whether the person in the cabin is in a sleeping status. The emotional information may include, but is not limited to, any one of the following expressions: angry, sad, calm, happy, depressed, etc.

In a possible implementation, the attribute of the person in the cabin may be recognized based on the face image to determine the attribute information of the cabin personnel, and the facial expression recognition and/or the eyes opening-closing recognition may be performed on the persons in the cabin based on the face image to determine the status information of the person in the cabin.

In a possible implementation, in the case where the attribute information includes age information, the age information may be recognized through the first neural network.

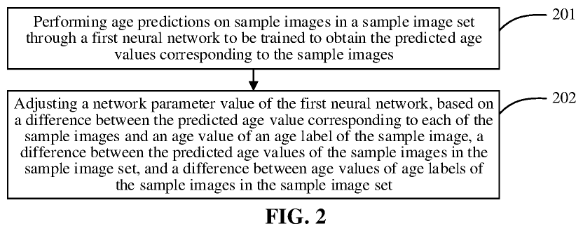

The training process of the first neural network may include the following operations according to the method illustrated in FIG. 2.

In operation 201, age predictions are performed on sample images in a sample image set through a first neural network to be trained to obtain the predicted age values corresponding to the sample images.

In operation 202, a network parameter value of the first neural network is adjusted, based on the difference between the predicted age value corresponding to each of the sample images and the age value of the age label of the sample image, the difference between the predicted age values of the sample images in the sample image set, and the difference between the age values of the age labels of the sample images in the sample image set.

In a possible implementation manner, according to different sample image sets, the above operations of adjusting the network parameter of the first neural network may be divided to the following situations.

In a first situation, the sample image set are multiple sample image sets.

In this situation, when a network parameter value of the first neural network is adjusted based on the difference between the predicted age value corresponding to each of the sample images and the age value of the age label of the sample image, the difference between the predicted age values of the sample images in the sample image set, and the difference between the age values of the age labels of the sample images in the sample image set, a network parameter value of the first neural network may be adjusted based on the difference between the predicted age value corresponding to each of the sample images and the age value of the age label of the sample image, the difference between the predicted age values of any two sample images in the same sample image set, and the difference between the age values of the age labels of the any two sample images.

In a possible implementation, the model loss value during training may be calculated by the following formula (1):

$$Formula ( 1 )$$

$${Age}_{loss} = {\sum }_{n = 0}^{N - 1} {smooth}_{l 1 \vert {predict}_{n} - {gt}_{n} \vert} + \frac{1}{N} {\sum }_{i = 0 , j = 1 , i != j}^{N - 1} smooth\_l1 \vert ( {predict}_{i} - {predict}_{j} ) - ( {gt}_{i} - {gt}_{j} ) \vert ;$$

where, Ageₗₒₛₛ represents the loss value during this training process, N represents the number of sample images, predictₙ represents the predicted age value of the n-th sample image, gtₙ represents the age value of the age label of the n-th sample image, and i traverses from 0 to N−1, j traverses from 0 to N−1, i and j are not equal.

After the loss value is calculated by the above formula, the network parameter value of the first neural network may be adjusted according to the calculated loss value.

In the first neural network trained by this method, the supervised data corresponding to the first neural network include not only the difference between the predicted age value and the age value of the age label, but also the difference between the predicted age values of the sample images in the sample image set and the difference between the age values of the age labels of the sample images in the sample image set, and therefore, the first neural network trained by this way is more accurate in age recognition.

In a second situation, the sample image set include multiple initial sample images, and an enhanced sample image corresponding to each sample image, and the enhanced sample image is an image obtained by performing information transformation processing on the initial sample image.

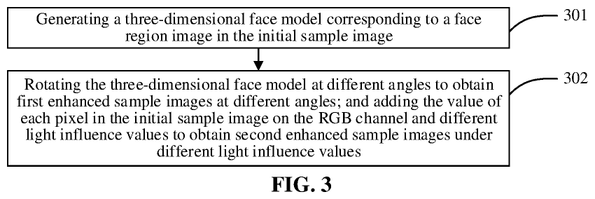

When determining the enhanced sample image corresponding to the initial sample image, the method illustrated in FIG. 3 may be used, and the method includes the following operations.

In operation 301, a three-dimensional face model corresponding to a face region image in the initial sample image is generated.

In operation 302, the three-dimensional face model is rotated at different angles to obtain first enhanced sample images at different angles; and the value of each pixel in the initial sample image on the RGB channel and different light influence values are added to obtain second enhanced sample images under different light influence values.

It should be noted that both the first enhanced sample images and the second enhanced sample images are enhanced sample images corresponding to the initial sample images.

When determining the second enhanced sample image, the value of each pixel point in the initial sample image on the RGB three-channel includes three values. When determining the second enhanced image under the light influence value, the values of all pixel points in the initial sample image on the three channels may be added with N, N is the light influence value and its value is a three-dimensional vector. In one possible situation, N may follow a Gaussian distribution.

In this situation, when a network parameter value of the first neural network is adjusted based on the difference between the predicted age value corresponding to each of the sample images and the age value of the age label of the sample image, the difference between the predicted age values of the sample images in the sample image set, and the difference between the age values of the age labels of the sample images in the sample image set, a network parameter value of the first neural network may be adjusted based on the difference between the predicted age value corresponding to each of the sample images and the age value of the age label of the sample image, and a difference between a predicted age value of the initial sample image and a predicted age value of the enhanced sample image corresponding to the initial sample image.

In a possible implementation, the loss value during the process of training the first neural network may be calculated according to the following formula (2):

$$Formula ( 2 )$$

$${Age}_{loss} = {\sum }_{n = 0}^{N - 1} {smooth}_{l 1 \vert {predict}_{n} - {gt}_{n} \vert} + \frac{1}{N} {\sum }_{n = 0}^{N - 1} smooth\_l1 \vert ( {predict}_{n} - {predict\_aug}_{n} \vert ;$$

Ageₗₒₛₛ represents the loss value during this training process, N represents the number of sample images, predictₙ represents the predicted age value of the n-th sample image, gtₙ represents the age value of the age label of the n-th sample image, and predict_augₙ represents the predicted age value of the enhanced sample image corresponding to the n-th sample image.

In the above method, the enhanced sample image is the sample image that the initial sample image is added with the influence of the angle and light. During the process of the age recognition, the neural network trained through the initial sample image and the enhanced sample image can avoid the influence of the angle and light on the accuracy of neural network recognition, and can improve the accuracy of age recognition.

In a third situation, the sample image set are multiple sample image sets, each of the sample image sets includes initial sample images, and an enhanced sample image corresponding to each of the initial sample images, and multiple initial sample images in the same sample image set are collected by the same image collection device.

In this situation, when a network parameter value of the first neural network is adjusted based on the difference between the predicted age value corresponding to each of the sample images and the age value of the age label of the sample image, the difference between the predicted age values of the sample images in the sample image set, and the difference between the age values of the age labels of the sample images in the sample image set, a loss value during this training process is calculated based on the difference between the predicted age value corresponding to each of the sample images and the age value of the age label of the sample image, the difference between the predicted age values of any two sample images in the same sample image set, the difference between the age values of the age labels of the any two sample images, and a difference between a predicted age value of the initial sample image and a predicted age value of the enhanced sample image corresponding to the initial sample image; and a network parameter value of the first neural network is adjusted based on the calculated loss value.

In a possible implementation, a first loss value is calculated, based on the difference between the predicted age value corresponding to each of the sample images and the age value of the age label of the sample image, the difference between the predicted age values of any two sample images in the same sample image set, and the difference between the age values of the age labels of the any two sample images; a second loss value is calculated based on a difference between a predicted age value of the initial sample image and a predicted age value of the enhanced sample image corresponding to the initial sample image; and then the sum of the first loss value and the second loss value is taken as the loss value during this training process.

In a possible implementation, the first loss value during the process of training the first neural network may be calculated according to the following formula (3):

$$Formula ( 3 ) \\ {Age}_{loss 1} = \frac{1}{M} {\sum }_{m = 0}^{M - 1} \frac{1}{N} {\sum }_{n = 0}^{N - 1} {smooth}_{l 1} \vert {predict}_{mi} - {predict}_{mj} ) - ( {gt}_{mi} - {gt}_{mj} ) \vert + \frac{1}{M} {\sum }_{m = 0}^{M - 1} \frac{2}{N ( N - 1 )} {\sum }_{i = 0 , j = 1 , i != j}^{N - 1} smooth\_l1 \vert ( {predict}_{mi} - {predict}_{mj} ) - ( {gt}_{mi} - {gt}_{mj} ) \vert ;$$

Ageₗₒₛₛ₁ represents the first loss value, M represents the number of sample image sets, N represents the number of sample images contained in each sample image set, and predictₘₙ represents the predicted age value of the n-th sample image in the m-th sample image set, gtₘₙ represents the age value of the age label of the n-th sample image in the m-th sample image set.

The second loss value during the process of training the first neural network may be calculated according to the following formula (4):

$$Formula ( 4 )$$

$${Age}_{loss 2} = \frac{1}{M} {\sum }_{m = 0}^{M - 1} \frac{1}{N} {\sum }_{n = 0}^{N - 1} smooth\_l1 \vert {predict}_{mn} - {predict\_aug}_{mn} \vert ;$$

Ageₗₒₛₛ₂ represents the second loss value, predictₘₙ represents the predicted age value of the n-th sample image in the m-th sample image set, and predict_augₘₙ represents the predicted age value of the enhanced sample image corresponding to the n-th sample image in the m-th sample image set.

Here, it should be noted that the number of sample images contained in each sample image set may also be greater than N, but during the process of training the first neural network, N sample images are randomly selected from each sample image set.

In a possible implementation, the network structure of the first neural network may include a feature extraction layer and an age information extraction layer. After the face image is input to the feature extraction layer, a feature map corresponding to the face image may be obtained, and then the feature map is input to the age information extraction layer, and the predicted age value of the face image is output.

Here, the initial sample images in the same sample image set are collected by the same image collection device, and therefore, when the neural network is trained by the sample images, the influence of errors caused by different image collection devices may be avoided; and at the same time, the neural network is trained by using the initial sample image and the enhanced sample image, which may avoid the influence of errors caused by light and angle, and therefore, the trained neural network has higher accuracy.

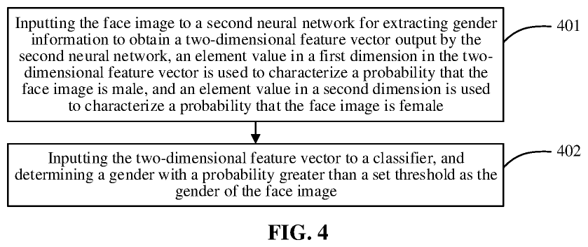

In the case where the attribute information includes gender information, when determining the gender information of the person in the cabin, the method illustrated in FIG. 4 may be referred to, and the method includes the following operations.

In operation 401, the face image is input to a second neural network for extracting gender information to obtain a two-dimensional feature vector output by the second neural network, an element value in a first dimension in the two-dimensional feature vector is used to characterize a probability that the face image is male, and an element value in a second dimension is used to characterize a probability that the face image is female.

In operation 402, the two-dimensional feature vector is input to a classifier, and a gender with a probability greater than a set threshold is determined as the gender of the face image.

The set threshold may be determined according to the image collection device that collects the face image and the collection environment.

Due to the influences of different image collection devices and collection environments, the recognition accuracy rate of the set threshold may be different with respect to different image collection devices and collection environments, and therefore, in order to avoid the influences of the image collection devices and collection environments, the embodiments of the present disclosure provide a method for adaptively determining a set threshold.

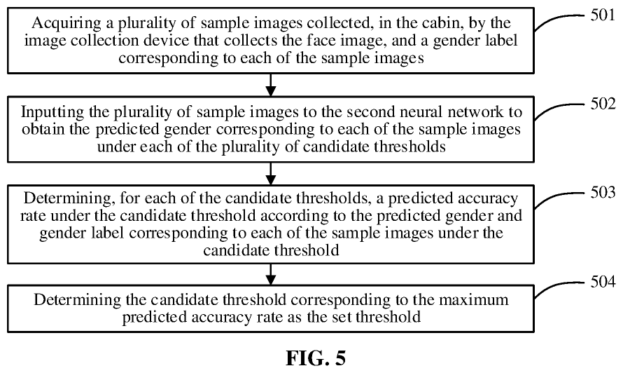

In a possible implementation, the method for determining the threshold value illustrated in FIG. 5 may be referred to, and the method includes the following operations.

In operation 501, multiple sample images collected in the cabin by the image collection device that collects the face image, and a gender label corresponding to each of the sample images is acquired.

Since the sample image and the face image have the same image collection device and collection environment, the set threshold determined by these sample images may satisfy the needs of the current environment.

In operation 502, the multiple sample images are input to the second neural network to obtain the predicted gender corresponding to each of the sample images under each of the multiple candidate thresholds.

In a possible implementation, the network structure of the second neural network may include a feature extraction layer and a gender information extraction layer. After the sample image is input to the second neural network, the sample image may be input to the feature extraction layer firstly to obtain the feature map corresponding to the sample image; and then the feature map is input to the gender information extraction layer and the two-dimensional feature vector is output, and then the predicted gender corresponding to the sample image is determined by using a classifier.

In a possible implementation, when determining the candidate threshold, multiple candidate thresholds may be selected from a preset value range according to a set step. In a practical application, since the values in different dimensions in the two-dimensional vector output by the second neural network represent probabilities, the preset value range may be 0 to 1, and the set step size may be, for example, 0.001. Exemplarily, the candidate threshold may be determined by the following formula (5):

thrd=0+0.001k Formula (5);

Where, thrd represents the candidate threshold, and k takes every positive integer from 0 to 1000.

In operation 503, for each of the candidate thresholds, a predicted accuracy rate under the candidate threshold is determined according to the predicted gender and gender label corresponding to each of the sample images under the candidate threshold.

When determining the predicted accuracy rate under the candidate threshold according to the predicted gender of the sample image under the candidate threshold and the gender label of the sample image under the candidate threshold, the following method may be used to determine:

As indicated in Table 1 below, The value of each of the following classifications in the P sample images is determined:

TABLE 1

gender label

| predicted gender | male | female |
|---|---|---|
| male | TP | TN |
| female | FP | FN |

Where, TP represents the number that gender label is male and the predicted gender is male under the thrd threshold, TN represents the number that gender label is male and the predicted gender is female under the thrd threshold, and FP represents the number that the gender label is female and the predicted gender is male under the thrd threshold, and FN represents the number that the gender label is female and the predicted gender is female under the thrd threshold.

After determining the value of each classification in the above Table 1, the accuracy rate may be calculated by the following formula (6):

$$F = \frac{2 P R}{P + R} \\ Where , P = \frac{T P}{T P + F P} , R = \frac{T P}{T P + F N} . \qquad Formula ( 6 ) ;$$

In operation 504, the candidate threshold corresponding to the maximum predicted accuracy rate is determined as the set threshold.

During the process of determining the set threshold, since the collected sample images are collected in the cabin by the image collection device that collects the face image, the influences of the collection device and the collection environment on the set threshold may be ensured. And during the process of determining the set threshold, the candidate threshold with the maximum predicted accuracy rate is taken as the set threshold, so that the set threshold may be adjusted adaptively, thereby improving the accuracy of gender recognition.

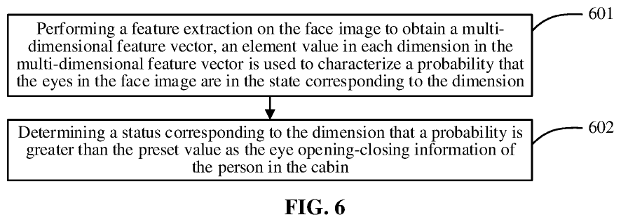

In the case where the status information includes eye opening-closing information, the eye opening-closing information of the person in the cabin may be determined according to the method illustrated in FIG. 6, and the method includes the following operations.

In operation 601, feature extraction is performed on the face image to obtain a multi-dimensional feature vector, an element value in each dimension in the multi-dimensional feature vector is used to characterize a probability that the eyes in the face image are in the state corresponding to the dimension.

In a possible implementation, the face image may be input to a fourth neural network which is pre-trained and is used for detecting eye opening-closing information. The fourth neural network may include a feature extraction layer and eye opening-closing information extraction layer. After the face image is input to the fourth neural network, the face image may be input to the feature extraction layer and the feature map corresponding to the face image is output, and then the feature map corresponding to the face image is input to the eye opening-closing information extraction layer and the multi-dimensional feature vector is output.

The status of the eye may include at least one of: no eyes being detected; the eyes being detected and the eyes opening; or the eyes being detected and the eyes closing.

In a possible implementation, the left eye status may be any of the above statuses, the right eye status may also be any of the above statuses, and there are nine possible statuses of the two eyes. Therefore, the output of the three neural network may be a nine-dimensional feature vector, and the element value in each dimension of the nine-dimensional feature vector represents a probability that the two eyes in the face image are in the status of the two eyes corresponding to the dimension.

In operation 602, a status corresponding to the dimension that a probability is greater than the preset value is determined as the eye opening-closing information of the person in the cabin.

It may be seen from the above contents that all of the first neural network used for age information extraction, the second neural network used for gender information extraction, the fourth neural network used for eye opening-closing information extraction, and therefore, these three neural networks may share the feature extraction layer.

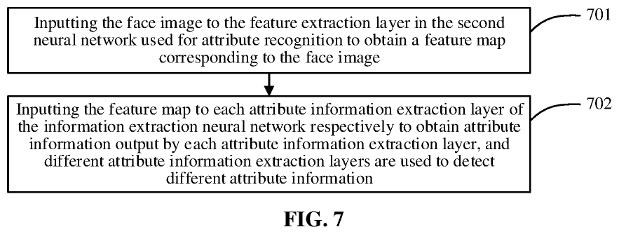

Exemplarily, with reference to FIG. 7 which is a method for determining attribute information according to an embodiment of the present disclosure, the method may include the following operations.

In operation 701, the face image is input to the feature extraction layer in the second neural network used for attribute recognition to obtain a feature map corresponding to the face image.

The feature extraction layer is used to perform feature extraction on the input face features. Exemplarily, the feature extraction layer may adopt the inception network, the lightweight network mobilenet-v2, etc.

In operation 702, the feature map is input to each attribute information extraction layer of the information extraction neural network respectively to obtain attribute information output by each attribute information extraction layer, and different attribute information extraction layers are used to detect different attribute information.

In a possible implementation, each attribute information extraction layer in the information extraction neural network includes a first full connection layer and a second full connection layer; and after the feature map is input to the attribute information extraction layer of the information extraction neural network, it is equivalent to input the feature map to the first full connection layer of the attribute information extraction layer firstly to obtain the M-dimensional vector corresponding to the feature map, M is a preset positive integer corresponding to any attribute information; and then the M-dimensional vector is input to the second full connection layer of the attribute information extraction layer to obtain the N-dimensional vector corresponding to the feature map, N is a positive integer, and M is greater than N, and N is the number of values of attribute information corresponding to the attribute information extraction layer; and finally, based on the obtained N-dimensional vector, the attribute information corresponding to the N-dimensional vector is determined.

N is the number of values corresponding to the attribute information extraction layer. It may be exemplarily understood that when the attribute information extracted by the attribute information extraction layer is gender, the values of the attribute information include both of “male” and “female”, and the value of N corresponding to the attribute information extraction layer is two.

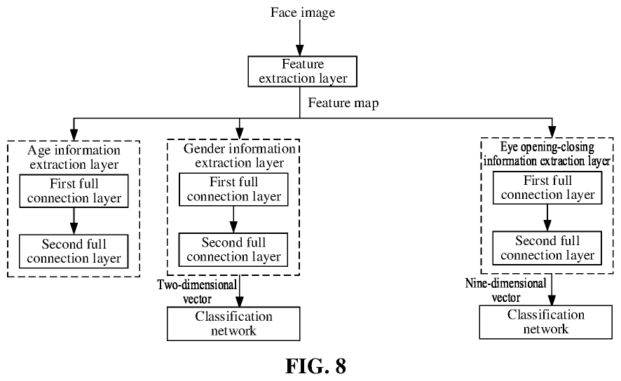

The following will take the attribute information including age information, and gender information as an example to describe the above structure of the information extraction neural network. The network structure of the information extraction neural network may be as illustrated in FIG. 8.

After the face image is input to the feature extraction layer, the feature map corresponding to the face image may be obtained, and then the feature map is input to the age information extraction layer, gender information extraction layer, and eye opening-closing information extraction layer, respectively.

The age information extraction layer includes the first full connection layer and the second full connection layer. After the feature map is input to the first full connection layer, the K₁-dimensional feature vector may be obtained, and then the K₁-dimensional feature vector is input to the second full connection layer to obtain a one-dimensional vector output, and the element value in the one-dimensional vector is the value of the predicted age. In addition, considering that the value of the age should be an integer, the element value in the one-dimensional vector may be rounded to obtain the predicted age information finally, and K₁ is greater than 1.

The gender information extraction layer includes the first full connection layer and the second full connection layer. After the feature map is input to the first full connection layer, the K₂-dimensional feature vector may be obtained; and then the K₂-dimensional feature vector is input to the second full connection layer to obtain a two-dimensional vector output, the element values in the two-dimensional vector represent the probability that the user is a male and a female for the input face image, respectively; and finally, the output of the second full connection layer may be connected to a two-classification network, and the gender information of the input face image predicted by the gender information extraction layer is determined according to the two-classification result, where K₂ is greater than 2.

In addition, the eye opening-closing information in the status information may also be extracted by using the above information extraction neural network. With respect to the eye opening-closing information extraction layer, the extracted contents are the status of the two eyes of the person in the cabin, the status of the eyes includes three types of “no eyes being detected” (no eyes being detected means that the eyes cannot be detected in the image, for example, the person in the cabin wear sunglasses), “the eyes being detected and the eyes opening” and “the eyes being detected and the eyes closing”. Therefore, there are nine optional statuses for two eyes. So that, with respect to the eye opening-closing information extraction layer, the output of the first full connection layer is a K₄-dimensional feature vector, and the output of the second full connection layer is a nine-dimensional feature vector, each element value in the vector is used to characterize the probability that the eye status of the person in the cabin in the face image is the status represented by the element value; the output of the second full connection layer is connected to a classification network, the eye opening-closing information of the input face image predicted by the eye opening-closing information extraction layer may be determined according to the classification result of the classification network, and K₄ is greater than 9.

During the process of training the information extraction neural network, the training may be performed by sample images with attribute information labels, the attribute information extraction layers are trained together; when calculating the loss value, the loss value of each attribute information extraction layer is calculated separately, and then the network parameter value of the corresponding attribute information extraction layer is adjusted according to the loss values of attribute information extraction layers, and the loss value of each attribute information extraction layer is summed as the total loss value; and then the network parameter value of the feature extraction layer is adjusted according to the total loss value. In a possible implementation, the process of training the information extraction neural network will not be introduced in detail here.

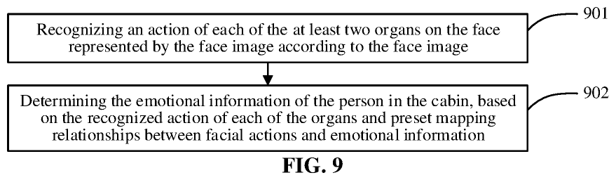

In a possible implementation, when determining the emotional information of the person in the cabin, the method as illustrated in FIG. 9 may be used, and the method includes the following operations.

In operation 901, an action of each of the at least two organs on the face represented by the face image is recognized according to the face image.

In operation 902, the emotional information of the person in the cabin is determined, based on the recognized action of each organ and preset mapping relationships between facial actions and emotional information.

When recognizing the action of each of the at least two organs on the face represented by the face image, the face image may be recognized through a third neural network, the third neural network includes a backbone network and at least two classification branch networks, each classification branch network is used to recognize an action of an organ on the face.

In a possible implementation, when the third neural network is used to recognize the face image, the backbone network may be used to extract the features of the face image to obtain the feature map of the face image; and then each classification branch network is used separately to perform action recognition according to the feature map of the face image, to obtain the occurrence probability of the action that may be recognized through each classification branch network; and then to determine the action with the occurrence probability greater than the preset probability as the action of the organ on the face represented by the face image.

In a possible implementation, before the face image is input to the third neural network, the face image may be preprocessed to enhance the key information in the face image, and then the preprocessed face image is input to the third neural network.

The preprocessing on the face image may be to firstly determine the position information of the key points in the face image, and then perform affine transformation on the face image based on the position information of the key points to obtain the converted image corresponding to the face image, the converted face image is normalized to obtain the processed face image.

The normalization processing on the converted face image includes as follows: the average value of the pixel value of each pixel point contained in the face image and the standard deviation of the pixel value of each pixel point contained in the face image are calculated; and the pixel value of each pixel point in the face image is normalized based on the average value of the pixel values and the standard deviation of the pixel values.

In a possible implementation, when the pixel value of each pixel point in the face image is normalized based on the average value of the pixel values and the standard deviation of the pixel values, the following formula (7) may be referred to.

$$Z = \frac{X - μ}{σ} ; \qquad Formula ( 7 )$$

Where Z represents the pixel value after the pixel point is normalized, and X represents the pixel value before the pixel point is normalized, μ represents the average value of the pixel values, and σ represents the standard deviation of the pixel values.

By the above processing, the face in the face image may be converted, which is more accurate in determining the facial expression.

The action detected by the action unit includes at least one of the following:

frown; stare; the corners of the mouth being raised; the upper lip being raised; the corners of the mouth being downwards; mouth being open.

According to the facial action detection results of the face and the preset mapping relationships between facial actions and emotional information, the emotional information of the person in the cabin may be determined. Exemplarily, when no facial action is detected, it may be determined that the emotional information of the person in the cabin is calm; and when it is detected that the facial actions of the person in the cabin are staring and opening the mouth, it may be determined that the emotional information of the person in the cabin is surprise.

Based on this manner, there is no need for the user to subjectively define the expression status of the face image. In addition, since the actions of the organs on the face may be focused on some specific facial features, recognition of the actions of the organs on the face image may improve accuracy compared to direct recognition on expressions and gestures.

With respect to operation 103:

Adjustments on environment settings in the cabin may include at least one of:

An adjustment on the type of music; an adjustment on the temperature; an adjustment on the type of light; and an adjustment on the smell.

In a possible implementation, when adjusting the environment settings in the cabin according to the attribute information and emotional information of the person in the cabin, if there is only one person in the cabin, the corresponding adjustment information may be directly found from the preset mapping relationship based on the attribute information and emotional information of the person in the cabin, and then the environment settings in the cabin are adjusted according to the adjustment information; the mapping relationship is used to represent the mapping relationship between the adjustment information, and the attribute information and emotional information.

If there are more than one person in the cabin, the value with a higher priority in the attribute information values of the persons in the cabin, and the value with a higher priority in the emotional information values of the persons in the cabin may be determined, and then the environment settings in the cabin may be adjusted according to the attribute information value with a higher priority and the emotional information value with a higher priority.

Exemplarily, if there are two persons in the cabin, one person's emotional information is calm, and the other person's emotional information is sad, the type of music played may be adjusted according to “sadness”.

In another possible implementation, since the attribute information is limited, the value of each attribute information is also limited, and the value of the status information is also limited, and therefore, the adjustment information corresponding to the value of each attribute information and the value of the emotional information may be set in advance, and then the corresponding adjustment information may be found based on the detected attribute information and emotional information of the person in the cabin.

Here, since the emotional information of the person in the cabin may change in real time, the environment settings in the cabin may be adjusted in real time according to the changes in the emotional information of the person in the cabin.

Those skilled in the art would understand that in the above methods of the specific implementation, the writing order of the steps does not mean a strict execution order to constitute any limitation on the implementation process. The execution order of the steps should be determined based on its function and possible inherent logic.

Based on the same inventive concept, the embodiments of the present disclosure further provide an apparatus for adjusting cabin environment corresponding to the method for adjusting cabin environment. Since the principle of the apparatus in the embodiments of the present disclosure to resolve the problem is similar to the above method for adjusting cabin environment in the embodiments of the present disclosure, the implementation of the apparatus may refer to the implementation of the method, and the repetition will not be repeated.

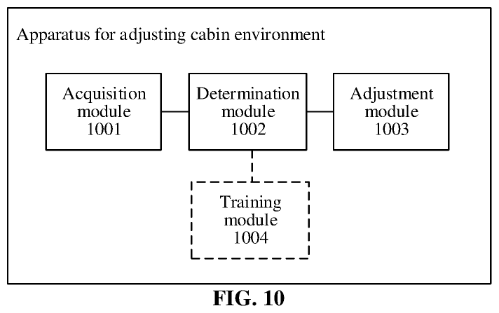

With reference to FIG. 10 which illustrates an architecture diagram of an apparatus for adjusting cabin environment according to an embodiment of the present disclosure, the apparatus includes an acquisition module 1001, a determination module 1002, an adjustment module 1003, and a training module 1004.

The acquisition module 1001 is configured to acquire a face image of a person in a cabin.

The determination module 1002 is configured to determine the attribute information and status information of the person in the cabin based on the face image.

The adjustment module 1003 configured to adjust the cabin environment based on the attribute information and status information of the person in the cabin.

In a possible implementation, the attribute information may include age information which is recognized through a first neural network.

The apparatus may further include a training module 1004. The training module 1004 may be configured to obtain the first neural network according to the following operations: age predictions are performed on sample images in sample image set through a first neural network to be trained to obtain the predicted age values corresponding to the sample images; and a network parameter value of the first neural network is adjusted, based on the difference between the predicted age value corresponding to each of the sample images and the age value of the age label of the sample image, the difference between the predicted age values of the sample images in the sample image set, and the difference between the age values of the age labels of the sample images in the sample image set.

In a possible implementation, the sample image set may be multiple sample image sets. The training module 1004 may be further configured to: adjust a network parameter value of the first neural network, based on the difference between the predicted age value corresponding to each of the sample images and the age value of the age label of the sample image, the difference between the predicted age values of any two sample images in the same sample image set, and the difference between the age values of the age labels of the any two sample images.

In a possible implementation, the sample image set may include multiple initial sample images, and an enhanced sample image corresponding to each of the initial sample images, and the enhanced sample image is an image obtained by performing information transformation processing on the initial sample image. The training module 1004 may be further configured to: adjust a network parameter value of the first neural network, based on the difference between the predicted age value corresponding to each of the sample images and the age value of the age label of the sample image, and a difference between a predicted age value of the initial sample image and a predicted age value of the enhanced sample image corresponding to the initial sample image. The sample images may be initial sample images or enhanced sample images.

In a possible implementation, the sample image set may be multiple sample image sets, each of the sample image sets may include multiple initial sample images, and an enhanced sample image corresponding to each of the initial sample images, the enhanced sample images may be images obtained by performing information transformation processing on the initial sample images, and multiple initial sample images in the same sample image set may be collected by the same image collection device. The training module 1004 may be further configured to: calculate a loss value during this training process, based on the difference between the predicted age value corresponding to each of the sample images and the age value of the age label of the sample image, the difference between the predicted age values of any two sample images in the same sample image set, the difference between the age values of the age labels of the any two sample images, and a difference between a predicted age value of the initial sample image and a predicted age value of the enhanced sample image corresponding to the initial sample image; and adjust a network parameter value of the first neural network based on the calculated loss value. The sample images may be initial sample images or enhanced sample images.

In a possible implementation, the training module 1004 may be further configured to: calculate a first loss value, based on the difference between the predicted age value corresponding to each of the sample images and the age value of the age label of the sample image, the difference between the predicted age values of any two sample images in the same sample image set, and the difference between the age values of the age labels of the any two sample images; calculate a second loss value based on a difference between a predicted age value of the initial sample image and a predicted age value of the enhanced sample image corresponding to the initial sample image; and take the sum of the first loss value and the second loss value as the loss value during this training process.

In a possible implementation, the training module 1004 may be further configured to determine the enhanced sample images corresponding to the initial sample images according to the following operations: a three-dimensional face model corresponding to a face region image in the initial sample images is generated; the three- dimensional face model is rotated at different angles to obtain first enhanced sample images at different angles; and the value of each pixel in the initial sample images on the RGB channel and different light influence values are added to obtain second enhanced sample images under different light influence values. The enhanced sample images may be the first enhanced sample images or the second enhanced sample images.

In a possible implementation, the attribute information may include gender information. The determination module 1002 may be further configured to determine the gender information of the person in the cabin according to the following operations: the face image is input to a second neural network for extracting gender information to obtain a two-dimensional feature vector output by the second neural network, an element value in a first dimension in the two-dimensional feature vector is used to characterize a probability that the face image is male, and an element value in a second dimension is used to characterize a probability that the face image is female; and the two-dimensional feature vector is input to a classifier, and a gender with a probability greater than a set threshold is determined as the gender of the face image.

In a possible implementation, the determination module 1002 may be further configured to determine the set threshold according to the following operations: multiple sample images collected in the cabin by the image collection device that collects the face image and a gender label corresponding to each of the sample images are acquired; the multiple sample images are input to the second neural network to obtain the predicted gender corresponding to each of the sample images under each of the multiple candidate thresholds; for each of the candidate thresholds, a predicted accuracy rate under the candidate threshold is determined according to the predicted gender and gender label corresponding to each of the sample images under the candidate threshold; and a candidate threshold corresponding to the maximum predicted accuracy rate is determined as the set threshold.

In a possible implementation, the determination module 1002 may be further configured to determine the multiple candidate thresholds according to the following operations: the multiple candidate thresholds are selected from a preset value range according to a set step size.

In a possible implementation, the status information may include eye opening-closing information. The determination module 1002 may be further configured to: determine the eye opening-closing information of the person in the cabin according to the following operations: feature extraction is performed on the face image to obtain a multi-dimensional feature vector, an element value in each dimension in the multi-dimensional feature vector is used to characterize a probability that the eyes in the face image are in the state corresponding to the dimension; and a status corresponding to the dimension that a probability is greater than the preset value is determined as the eye opening-closing information of the person in the cabin.

In a possible implementation, the status of the eye may include at least one of: no eyes being detected; the eyes being detected and the eyes opening; and the eyes being detected and the eyes closing.

In a possible implementation, the status information may include emotional information. The determination module 1002 may be further configured to determine the emotional information of the person in the cabin according to the following operations: an action of each of the at least two organs on the face represented by the face image is recognized according to the face image; the emotional information of the person in the cabin is determined based on the recognized action of each organ and preset mapping relationships between facial actions and emotional information.

In a possible implementation, the actions of the organs on the face may include at least two of: frown; stare; the corners of the mouth being raised; the upper lip being raised; the corners of the mouth being downwards; mouth being open.

In a possible implementation, the operation that an action of each of the at least two organs on the face represented by the face image is recognized according to the face image may be performed by a third neural network, the third neural network may include a backbone network and at least two classification branch networks, each of the classification branch networks may be used to recognize an action of an organ on a face.

The determination module 1002 may be further configured to: perform feature extraction on the face image by using the backbone network to obtain a feature map of the face image; perform action recognition on the feature map of the face image by using each of the classification branch networks to obtain an occurrence probability of an action capable of being recognized through each of the classification branch networks; and determine an action that an occurrence probability is greater than the preset probability as the action of the organ on the face represented by the face image.

In a possible implementation, the adjustments on environment settings in the cabin may include at least one of: an adjustment on the type of music; an adjustment on the temperature; an adjustment on the type of light; and an adjustment on the smell.

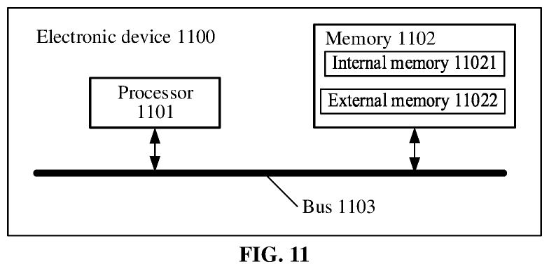

Based on the same technical concept, the embodiments of the present disclosure further provide an electronic device. With reference to FIG. 11 which illustrates a schematic diagram of an electronic device 1100 according to an embodiment of the present disclosure, the electronic device 1100 includes a processor 1101, a memory 1102 and a bus 1103. The memory 1102 is configured to store execution instructions, including an internal memory 11021 and an external memory 11022; here, the internal memory 11021 is also referred to as an internal storage, and is configured to temporarily store arithmetic data in the processor 1101 and temporarily store data exchanged with the external memory 11022 such as hard disk, the processor 1101 exchanges data with the external memory 11022 through the internal memory 11021. When the electronic device 1100 is running, the processor 1101 and the memory 1102 communicate with each other through the bus 1103, so that the processor 1101 executes the operations in the method of adjusting cabin environment described in the above method embodiment.

The embodiments of the present disclosure further provide a computer-readable storage medium having stored therein a computer program that when executed by a processor, implements the method for adjusting cabin environment described in the above method embodiment is executed, the storage medium may be a volatile or nonvolatile computer readable storage medium.

The computer program product of the method for adjusting cabin environment according to the embodiments of the present disclosure includes a computer-readable storage medium storing program code, and the instructions included in the program code may be used to execute the steps in the method for adjusting cabin environment described in the above method embodiment, and reference may be made to the above method embodiment, which will not be repeated here.

The embodiments of the present disclosure further provide a computer program that when executed by a processor, implements any one of the methods in the above embodiments. The computer program product may be implemented by hardware, software, or a combination thereof. In an optional embodiment, the computer program product is embodied as a computer storage medium. In another optional embodiment, the computer program product is embodied as a software product, such as a software development kit (SDK).

Those skilled in the art would clearly understand that, for the convenience and conciseness of the description, the working process of the system and apparatus described above may refer to the corresponding process in the above method embodiment, which will not be repeated here. In the several embodiments according to the present disclosure, it should be understood that the disclosed system, apparatus, and method may be implemented in other manners. The apparatus embodiment described above are merely exemplarily. For example, the division of the units is merely a logical function division, and there may be other division manners in actual implementation. For another example, multiple units or components may be combined or may be integrated into another system, or some features may be ignored or not implemented. In addition, the displayed or discussed mutual couplings or direct couplings or communication connections may be indirect couplings or communication connections between apparatuses or units through some communication interfaces, and may be in electrical, mechanical or other forms.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments.

In addition, the functional units in the various embodiments of the present disclosure may be integrated into one processing unit, or each unit may exist alone physically, or two or more units may be integrated into one unit.

When the function is implemented in the form of a software function unit and sold or used as an independent product, it may be stored in a non-volatile computer readable storage medium executable by a processor. Based on this understanding, the technical solutions in the embodiments of the present disclosure may be embodied in the form of software products in essence or parts that contribute to the prior art or parts of the technical solutions, and the computer software product is stored in a storage medium, including several instructions to make a computer device (which may be a personal computer, a server, or a network device, etc.) execute all or part of the steps in the methods described in the various embodiments of the present disclosure. The above storage media include various media that may store program codes, such as a U disk, a removable hard disk, a read-only memory (ROM), a random access memory (RAM), a magnetic disk or an optical disk.

Finally, it should be noted that the above embodiments are merely specific implementations of the present disclosure, which do not limit the present disclosure, but are used to illustrate the technical solutions of the present disclosure, and the protection scope of the present disclosure is not limited thereto, although the present disclosure has been described in detail with reference to the above embodiments, those of ordinary skill in the art would understand that any skilled person familiar with the art can still modify or easily conceive of changes to the technical solutions described in the above embodiments, or make equivalent substitution for some of the technical features within the technical scope disclosed in the embodiments of the present disclosure. These modifications, changes or substitutions do not separate the essence of the corresponding technical solutions from the spirit and scope of the technical solution in the embodiments of the present disclosure, and should be covered within the protection scope of the present disclosure. Therefore, the protection scope of the embodiments of the present disclosure shall be subject to the protection scope of the claims.

### INDUSTRIAL APPLICABILITY

In the embodiments of the present disclosure, the face image of the person in the cabin is acquired, the attribute information and status information of the person in the cabin are determined based on the face image, the cabin environment is adjusted based on the attribute information and status information of the person in the cabin. In this way, since the face image is acquired in real time, the determined attribute information and status information of the person in the cabin can represent the current status of the person in the cabin, the environment settings in the cabin can be adjusted according to the current status of the person in the cabin, and the environment settings in the cabin can be adjusted automatically and dynamically.

1. A method for adjusting cabin environment, comprising:
acquiring a face image of a person in a cabin;
determining attribute information and status information of the person in the cabin based on the face image; and
adjusting the cabin environment based on the attribute information and the status information of the person in the cabin.

2. The method according to claim 1, wherein the attribute information comprises age information, the age information is recognized through a first neural network;
the first neural network is obtained according to a manner of:
performing age predictions on sample images in a sample image set through a first neural network to be trained to obtain predicted age values corresponding to the sample images; and
adjusting a network parameter value of the first neural network, based on a difference between the predicted age value corresponding to each of the sample images and an age value of an age label of the sample image, a difference between the predicted age values of the sample images in the sample image set, and a difference between age values of age labels of the sample images in the sample image set.

3. The method according to claim 2, wherein the sample image set is a plurality of sample image sets;
the adjusting the network parameter value of the first neural network, based on the difference between the predicted age value corresponding to each of the sample images and the age value of the age label of the sample image, the difference between the predicted age values of the sample images in the sample image set, and the difference between the age values of the age labels of the sample images in the sample image set, comprises:
adjusting the network parameter value of the first neural network, based on the difference between the predicted age value corresponding to each of the sample images and the age value of the age label of the sample image, a difference between predicted age values of any two sample images in a same sample image set, and a difference between age values of age labels of the any two sample images.

4. The method according to claim 2, wherein the sample image set comprise a plurality of initial sample images, and an enhanced sample image corresponding to each of the initial sample images, and the enhanced sample image is an image obtained by performing an information transformation processing on the initial sample image;
the adjusting the network parameter value of the first neural network, based on the difference between the predicted age value corresponding to each of the sample images and the age value of the age label of the sample image, the difference between the predicted age values of the sample images in the sample image set, and the difference between the age values of the age labels of the sample images in the sample image set, comprises:
adjusting the network parameter value of the first neural network, based on the difference between the predicted age value corresponding to each of the sample images and the age value of the age label of the sample image, and a difference between a predicted age value of the initial sample image and a predicted age value of the enhanced sample image corresponding to the initial sample image;
wherein the sample images are initial sample images or enhanced sample images.

5. The method according to claim 2, wherein the sample image set is a plurality of sample image sets, each sample image set comprises a plurality of initial sample images, and an enhanced sample image corresponding to each of the initial sample images, the enhanced sample image is an image obtained by performing an information transformation processing on the initial sample image, and a plurality of initial sample images in a same sample image set are collected by a same image collection device;
the adjusting the network parameter value of the first neural network, based on the difference between the predicted age value corresponding to each of the sample images and the age value of the age label of the sample image, the difference between the predicted age values of the sample images in the sample image set, and the difference between the age values of the age labels of the sample images in the sample image set, comprises:
calculating a loss value during this training process, based on the difference between the predicted age value corresponding to each of the sample images and the age value of the age label of the sample image, a difference between predicted age values of any two sample images in a same sample image set, a difference between age values of age labels of the any two sample images, and a difference between a predicted age value of the initial sample image and a predicted age value of the enhanced sample image corresponding to the initial sample image; and adjusting the network parameter value of the first neural network based on the calculated loss value;
wherein the sample images are initial sample images or enhanced sample images.

6. The method according to claim 5, wherein the calculating the loss value during this training process, based on the difference between the predicted age value corresponding to each of the sample images and the age value of the age label of the sample image, the difference between the predicted age values of the any two sample images in the same sample image set, the difference between the age values of the age labels of the any two sample images, and the difference between the predicted age value of the initial sample image and the predicted age value of the enhanced sample image corresponding to the initial sample image, comprises:
calculating a first loss value, based on the difference between the predicted age value corresponding to each of the sample images and the age value of the age label of the sample image, the difference between the predicted age values of the any two sample images in the same sample image set, and the difference between the age values of the age labels of the any two sample images;
calculating a second loss value, based on the difference between the predicted age value of the initial sample image and the predicted age value of the enhanced sample image corresponding to the initial sample image; and
taking a sum of the first loss value and the second loss value as the loss value during this training process.

7. The method according to claim 4, wherein the enhanced sample image corresponding to the initial sample image is determined according to a manner of:
generating a three-dimensional face model corresponding to a face region image in the initial sample image;
rotating the three-dimensional face model at different angles to obtain first enhanced sample images at the different angles; and
adding a value of each pixel point in the initial sample image on a RGB channel and different light influence values to obtain second enhanced sample images under the different light influence values;
wherein the enhanced sample images are the first enhanced sample images or the second enhanced sample images.

8. The method according to claim 1, wherein the attribute information comprises gender information, and the gender information of the person in the cabin is determined according to a manner of:
inputting the face image to a second neural network for extracting the gender information to obtain a two-dimensional feature vector output by the second neural network, wherein an element value in a first dimension in the two-dimensional feature vector is used to characterize a probability that the face image is male, and an element value in a second dimension is used to characterize a probability that the face image is female; and
inputting the two-dimensional feature vector to a classifier, and determining a gender with a probability greater than a set threshold as a gender of the face image.

9. The method according to claim 8, wherein the set threshold is determined according to a manner of:
acquiring a plurality of sample images collected, in the cabin, by an image collection device that collects the face image, and a gender label corresponding to each of the sample images;
inputting the plurality of sample images to the second neural network to obtain a predicted gender corresponding to each of the sample images under each of a plurality of candidate thresholds;
determining, for each of the candidate thresholds, a predicted accuracy rate under the candidate threshold according to the predicted gender and the gender label corresponding to each of the sample images under the candidate threshold; and
determining a candidate threshold corresponding to a maximum predicted accuracy rate as the set threshold.

10. The method according to claim 9, wherein the plurality of candidate thresholds are determined according to a manner of:
selecting the plurality of candidate thresholds from a preset value range according to a set step size.

11. The method according to claim 1, wherein the status information comprises eye opening-closing information, and the eye opening-closing information of the person in the cabin is determined according to a manner of:
performing a feature extraction on the face image to obtain a multi-dimensional feature vector, wherein an element value in each dimension in the multi-dimensional feature vector is used to characterize a probability that eyes in the face image are in a state corresponding to the dimension; and
determining a status corresponding to the dimension that a probability is greater than a preset value as the eye opening-closing information of the person in the cabin.

12. The method according to claim 11, wherein a status of eyes comprises at least one of:
no eyes being detected; the eyes being detected and the eyes opening; or the eyes being detected and the eyes closing.

13. The method according to claim 1, wherein the status information comprises emotional information, and the emotional information of the person in the cabin is determined according to a manner of:
recognizing an action of each of at least two organs on a face represented by the face image according to the face image; and
determining the emotional information of the person in the cabin, based on the recognized action of each of the organs and preset mapping relationships between facial actions and emotional information.

14. The method according to claim 13, wherein the actions of the organs on the face comprise at least two of:
frown; stare; corners of a mouth being raised; an upper lip being raised; the corners of the mouth being downwards; or the mouth being open.

15. The method according to claim 13, wherein the operation of recognizing the action of each of the at least two organs on the face represented by the face image according to the face image is performed by a third neural network, the third neural network comprises a backbone network and at least two classification branch networks, each of the classification branch networks is used to recognize an action of an organ on a face;
the recognizing the action of each of the at least two organs on the face represented by the face image according to the face image comprises:
performing a feature extraction on the face image by using the backbone network to obtain a feature map of the face image;
performing an action recognition on the feature map of the face image by using each of the classification branch networks to obtain an occurrence probability of an action capable of being recognized through each of the classification branch networks; and
determining an action that an occurrence probability is greater than a preset probability as the action of the organ on the face represented by the face image.

16. The method according to claim 1, wherein adjustments on environment settings in the cabin comprises at least one of:
an adjustment on a type of music; an adjustment on temperature; an adjustment on a type of light; or an adjustment on a smell.

17. An electronic device, comprising: a processor, a memory storing machine-readable instructions executable by the processor, and a bus; wherein the processor is configured to:
acquire a face image of a person in a cabin;
determine attribute information and status information of the person in the cabin based on the face image; and
adjust cabin environment based on the attribute information and the status information of the person in the cabin.

18. The electronic device according to claim 17, wherein the attribute information comprises age information, the age information is recognized through a first neural network;
the processor is further configured to obtain the first neural network according to a manner of:
performing age predictions on sample images in a sample image set through a first neural network to be trained to obtain predicted age values corresponding to the sample images; and
adjusting a network parameter value of the first neural network, based on a difference between the predicted age value corresponding to each of the sample images and an age value of an age label of the sample image, a difference between the predicted age values of the sample images in the sample image set, and a difference between age values of age labels of the sample images in the sample image set.

19. The electronic device according to claim 18, wherein the sample image set is a plurality of sample image sets;
the processor is further configured to: adjust the network parameter value of the first neural network, based on the difference between the predicted age value corresponding to each of the sample images and the age value of the age label of the sample image, a difference between predicted age values of any two sample images in a same sample image set, and a difference between age values of age labels of the any two sample images.

20. A non-transitory computer-readable storage medium having stored therein a computer program that when executed by a processor, implements a method for adjusting cabin environment, wherein the method comprise:
acquiring a face image of a person in a cabin;
determining attribute information and status information of the person in the cabin based on the face image; and
adjusting the cabin environment based on the attribute information and the status information of the person in the cabin.
